(19) United States
(12) Patent Application Publication
(10) Pub. No.: US 2006/0125904 A1
(43) Pub. Date: Jun. 15, 2006

(54) Safety circuit for image forming apparatus

(75) Inventor: Takeharu Shokai, Tagata-gun (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/011,062

(22) Filed: Dec. 15, 2004

(51) Int. Cl. B41J 29/13

(52) U.S. Cl. 347/108

(57) ABSTRACT

A safety circuit for an image forming apparatus includes a main switch configured to allow power supply from a main power source to be switched in an ON/OFF fashion, an openable/closable cover, a cover switch configured to be turned OFF when the cover is opened and be turned ON when the cover is closed, a load, a load power source configured to be connected through the main switch and cover switch to the main power source to supply power which is generated based on power from the main power source to the load, a safety switch configured to promptly discharge a remaining charge on the load and the load power source, and a controller configured to, when the cover switch is turned OFF with the main switch ON, issue an instruction to the safety switch to immediately discharge the remaining charge.

### BACKGROUND OF THE INVENTION

1. Field of the Invention

The present invention relates to a safety circuit adapted for the safe opening of various kinds of covers of an image forming apparatus.

2. Description of the Related Art

Along with the increased functionality of image forming apparatuses, an output supply capability of a power source has been improved. When, therefore, various kinds of covers are opened, it is necessary to secure safety such that an operator is never exposed to a dangerous situation. When, for example, a front cover is opened, a power supply from a power source to an associated apparatus is interrupted with the use of, for example, an interlock switch to secure safety.

However, even if a power supply from the power source is interrupted with such an interlock switch, a charge is stored on a load-side capacitor, etc., and it takes some time to completely discharge the remaining charge there. If, therefore, any remaining charge is present there, respective devices in an MFP1 continue their operations due to the power supplied from the remaining charge. At a time of opening a front cover, for example, if any charge remains on the load side, each unit inside the apparatus is still operating. Where, therefore, the operator opens the front cover and any maintenance, etc., is done on the respective units inside the apparatus, there are sometimes the cases where he or she is exposed to a dangerous situation.

Therefore, there is a growing need to provide a safety circuit with which an operator can safely open various kinds of covers on an image forming apparatus.

### BRIEF SUMMARY OF THE INVENTION

An aspect of the present invention there is provided a safety circuit for an image forming apparatus comprising: a main switch configured to allow a power supply from a main power source to be switched in an ON/OFF fashion; an openable/closable cover; a cover switch configured to be turned OFF when the cover is opened and be turned ON when the cover is closed; a load; a load power source configured to be connected through the main switch and cover switch to the main power source to supply power which is generated based on power supplied from the main power source; a safety switch configured to promptly discharge a charge remaining on the load and load power source; and a controller configured to, when the cover switch is turned OFF with the main switch ON, issue an instruction to the safety switch to immediately discharge the remaining charge.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a view showing an outer appearance of an MFP in a first embodiment of the present invention;

FIG. 2 is a view showing an outer appearance of the MFP when its front cover is opened;

FIG. 3 is a cross-sectional view diagrammatically showing a conveying system of the MFP;

FIG. 4 is a view showing one portion of a main section of a control structure of the MFP;

FIG. 5 is a view showing another portion of the main section of the control structure of the MFP;

FIG. 6 is a view showing a safety circuit in the same embodiment; and

FIG. 7 is a view showing a safety circuit in a second embodiment of the present invention.

### DETAILED DESCRIPTION OF THE INVENTION

With reference to the drawing, an explanation will be made below about respective embodiments of the present invention.

### FIRST EMBODIMENT

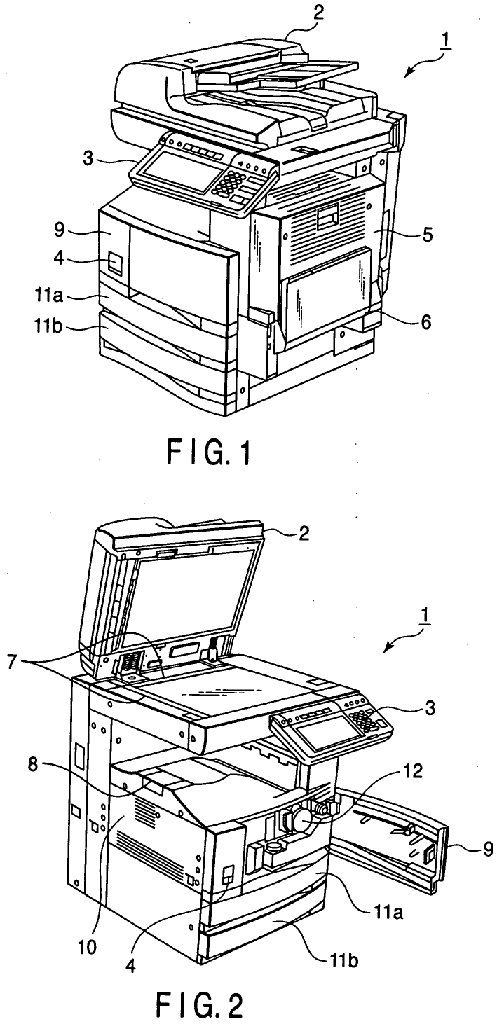

FIG. 1 is a view showing an outer appearance of a multi-function peripheral (MFP)1 constituting an image forming apparatus. FIG. 2 is a view as seen looking at the apparatus from another angle in FIG. 1 in a state of opening a front cover.

As shown in FIGS. 1 and 2, the MFP1 comprises an auto-document feeder (ADF)2 for continuously feeding document sheets, a control panel 3 having keys for receiving an instruction from the user and a touch panel, a main switch 4 for allowing a power supply from a main power source to be switched in an ON/OFF fashion, an automatic duplexing unit (ADU)5 for allowing a sheet to be inverted when both sides of the sheet are printed, a manual feed type sheet tray 6, a document scale 7 for checking the size of the document sheet, a sheet discharge tray 8 for allowing a discharged sheet to be set thereon, a front cover 9 for opening/closing to be done for maintenance, such as an exchange of a toner 12, a side cover 10, a sheet storage cassette 11a, a sheet storage cassette 11b at a lower side of the cassette 11a, and so on. The sheet storage cassettes 11a and 11b are provided for storing predetermined sizes of sheets.

As shown in FIG. 2, the MFP1 is so designed that, by opening the front cover 9, the operator can do maintenance, such as the exchange of the toner 12.

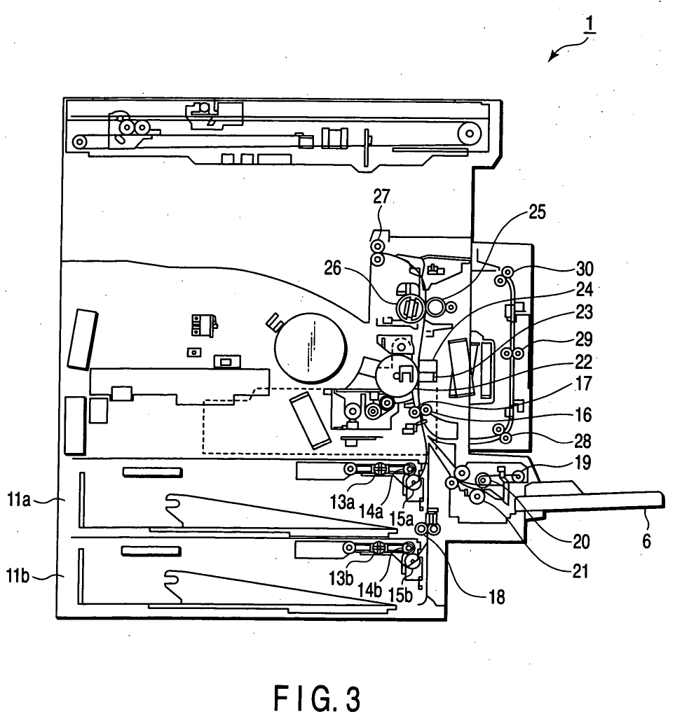

FIG. 3 is a view diagrammatically showing a cross-section of the MFP1. By use of FIG. 3, an explanation will be made about a sheet conveying path for forming an image. It is to be noted that FIG. 3 is an explanatory view for a sheet conveying path and no ADF2 is shown in FIG. 3.

The conveying of the sheet is done by receiving an instruction from the control panel 3. A designated size of sheet is supplied from the cassette 11a, cassette 11b or manual feed type sheet tray 6. When the sheet is conveyed from the upper side cassette 11a, it is picked up by the cassette pick-up roller 13a. The picked-up sheet is fed up to register rollers 16, 17 by the cassette sheet supply roller 14a and cassette separation roller 15a. When, on the other hand, the sheet is conveyed from the lower side cassette 11, it is picked up by the pick-up roller 13b and, after being separated by the cassette sheet roller 14b and cassette separation roller 15b, fed up to the register rollers 16, 17 by a cassette sheet conveying roller 18. Further, when the sheet from the manual feed sheet tray 6 is conveyed, the sheet which is set on the manual feed tray 6 is picked up by a manual feed type pick-up roller 19 and then supplied up to the register rollers 16, 17 by a manual feed type supply roller 20 and a manual feed type separation roller 21.

The sheet which is supplied up to the register rollers 16, 17 is fed between a drum 22 and a transfer charger 23 in time with the rotation of the drum 22 with a predetermined toner image formed thereon. So the toner image formed on the drum 22, a predetermined voltage is applied by a transfer charger 23, is transferred to the sheet. When the toner image is transferred to the sheet, a predetermined voltage is applied by a separation charger 24 located on the upper side of the transfer charger 23 and, by doing so, the sheet is separated from the drum 22.

The sheet with a transferred toner image is conveyed between a pressing roller 25 and a heating roller 26 in a fixing device. The transferred image on the sheet is fixed to the sheet by the pressing roller 25 and heating roller 26. The sheet with a fixed image is delivered by a discharge roller 27 onto the sheet delivery tray 8. Where both the sides of the paper are to be printed, it follows that, after the image has been fixed to the sheet by the pressing roller 25 and heating roller 26, a resultant sheet is conveyed by ADU conveying rollers 30, 29 and 28 in a manner to have its one sheet side inverted and then conveyed to the register rollers 16, 17. The thus inverted sheet, after having been subjected again to an image forming process and an image fixing process, is delivered by the discharge roller 27 onto the sheet delivery tray 8.

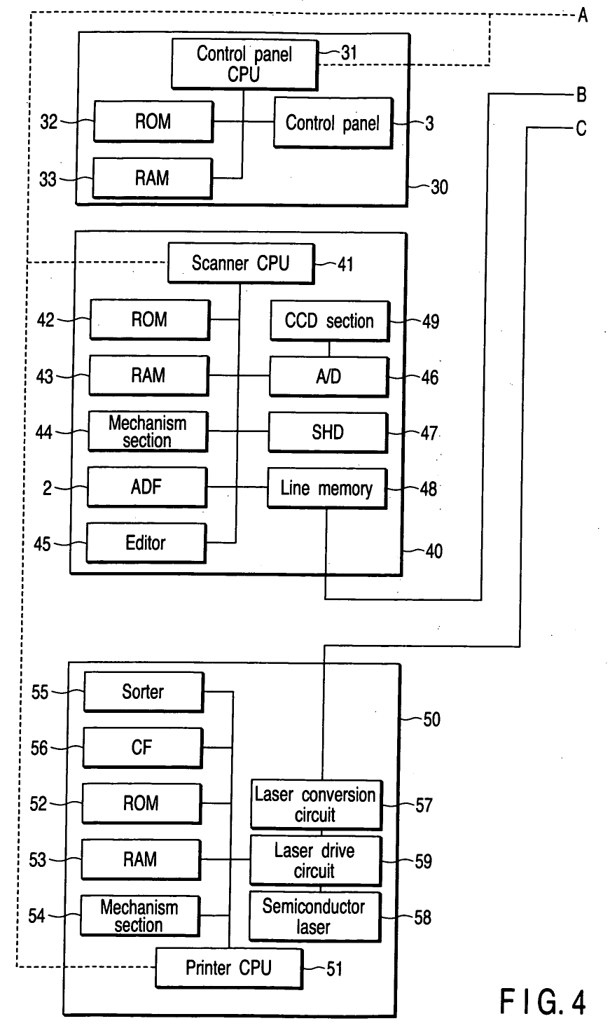

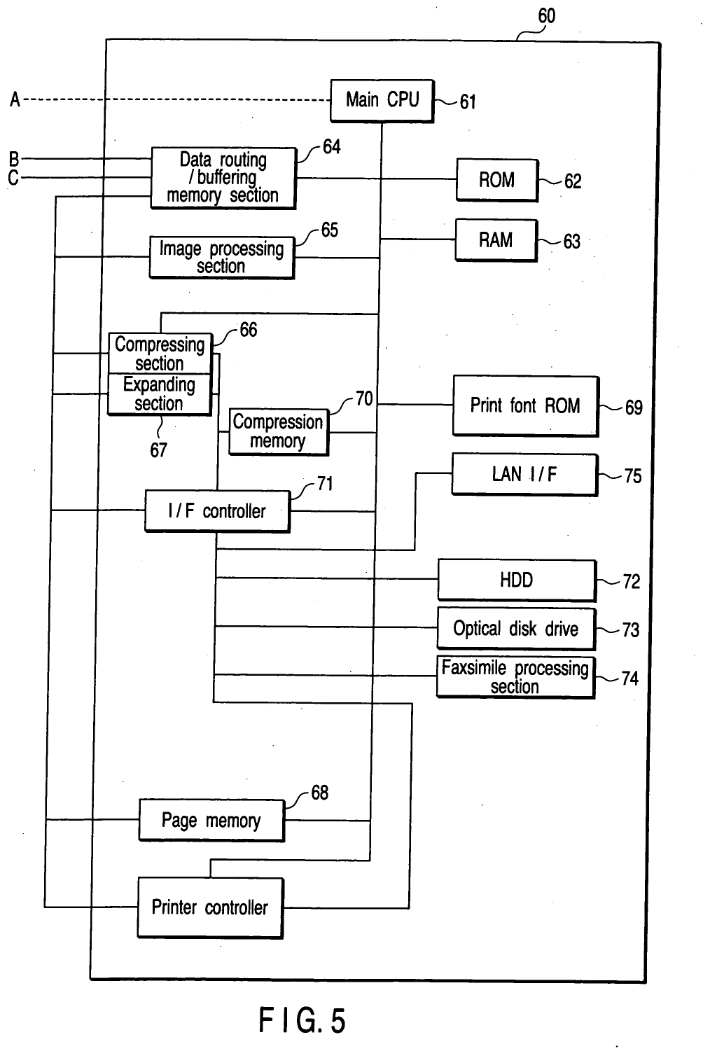

With reference to FIGS. 4 and 5 an explanation will be made below about the main section of a control structure in the MFP1. As shown in FIGS. 4 and 5, a main CPU61, control panel CPU31, scanner CPU41 and printer CPU51 control a basic processing section 60, control panel 30, scanning section 40 and printer section 50, respectively. Further, the main CPU61 communicates with the control panel CPU31, scanner CPU41 and printer CPU51 and controls these CPUs.

The control panel CPU31 is connected to a ROM32 and RAM33. The control panel CPU31 controls, for example, based on data stored in the ROM32 and RAM33, the keys on the control panel 3 as well as the touch panel.

The scanner CPU41 controls, for example, based on data stored in a ROM42 and RAM43, a mechanism section 44 such as a motor and solenoid (not shown) and controls an ADF2, coordinate input device (editor) 45, analog/digital (A/D) converter circuit 46, shading correction circuit (SHD)47, line memory 48. To the A/D circuit a charge coupled device (CCD)49 is connected.

The printer CPU51 controls, for example, based on data stored in a ROM52 and RAM53, a mechanism section 54 such as a motor and solenoid (not shown) and controls a sorter 55, cassette feeder (CF) 56 composed of for example, the cassette sheet pick-up roller 13a, cassette sheet supply roller 14a, cassette sheet separation roller 15a, etc., laser conversion circuit 57, laser drive circuit 59 for controlling a semiconductor laser 58.

The main CPU61 performs overall control of the MFP1 in accordance with a control program stored in a ROM62 and RAM63.

A data routing/buffering memory section 64 allows image data which is read out by the scanning section 40 to be routed to any specific location and allows any specific data to be sent to the printer section 50 and, effects a data buffering operation. The image processing section 65 performs image processing, for example, on the data read out by the scanning section 40, that is, on the data sent from the data routing/buffering memory section 64. A compressing section 66 allows the image data to be compressed, while, on the other hand, an expanding section 67 allows the compressed image data to be expanded. A page memory 68 stores the image data for each page. A print font ROM69 expands code data on the page memory 68 and a compression memory 70 stores the data which is compressed by the compressing section 66.

The main CPU61 is connected through an I/F controller 71 to a hard disk drive (HDD)72, optical disk drive 73, facsimile processing section 74 and local area network interface (LAN I/F)75. The HDD72 stores various kinds of data such as image data. The optical disk drive 73 reads out information which is stored in a disk set therein. The facsimile processing section 74 forwards the processed image data to the exterior through a communication line (not shown) connected to the MFP1 or receives image data as an input from the exterior through the communication line. The LAN I/F75 is used to communicate with a personal computer (not shown) which is connected to the MFP1 via the LAN.

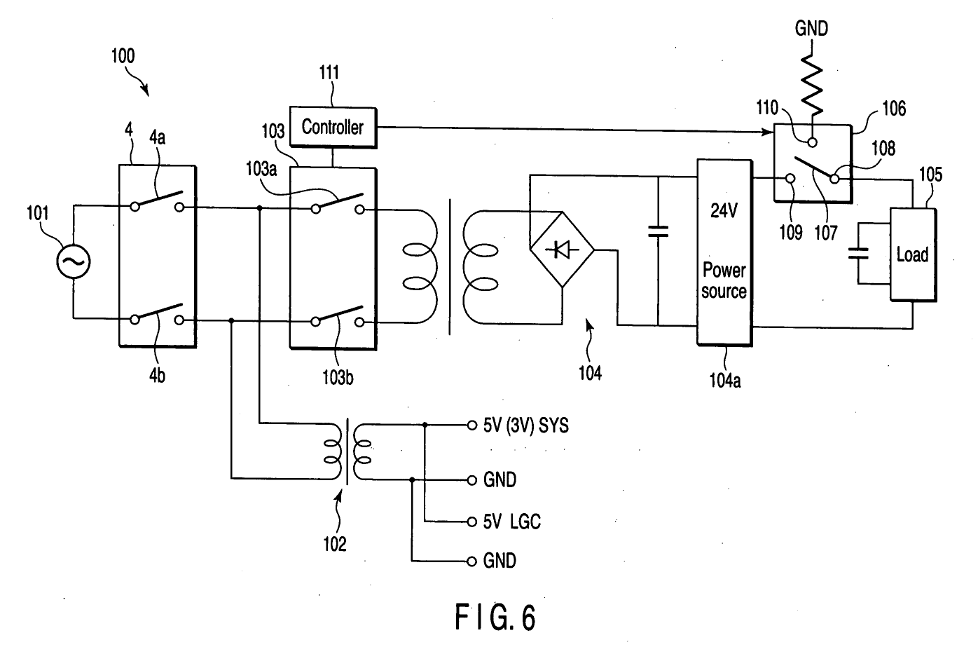

FIG. 6 is a view for explaining a safety circuit 100 which is provided to safely open a front cover 9 of the MFP1 thus structured.

A power generation section 102 is connected through a main switch 4 to a main power source 101. The power generation section 102 generates a power of 5V. The 5V power is supplied from the power generation section 102 to a system (SYS) section and logic circuit (LGC) in the MFP1. It is to be noted that, if a 3V power supply is required in the system section, a 3V power is further generated from a power generation section, not shown, and supplied.

To the main power source 101, a power generation section 104 is connected through the main switch 4 and cover switch 103. It is to be noted that the main switch 4 has two switches (4a, 4b) and the cover switch has two switches (103a, 103b). The following is the reason why the two switches are provided in the main switch 4 and in the cover switch 103. That is, if only one switch is provided in the main switch and in the cover switch in the case where an AC current is supplied from the exterior, it follows that, when either is grounded in the circuit, a current flows even if the switch is turned OFF. The cover switch 103 is so operated that it is turned ON/OFF in synchrony with the closing/opening of the front cover 9 and side cover 10. With both the front cover 9 and side cover 10 closed, both switches 103a and 103b in the cover switch 103 are turned ON and, with at least one of the front cover 9 and side cover 10 opened, both the switches 103a and 103b in the cover switch 103 are turned OFF.

The power generation section 104 includes a rectifier circuit, capacitor and 24V power source 104a provided to supply power to a load 105. The load 105 is comprised of, for example, a motor for a high voltage circuit and for a conveying system. The motor for the conveying system is used for the cassette sheet pick-up rollers 13a, 13b, cassette sheet supply rollers 14a, 14b, cassette sheet separation rollers 15a, 15b, register rollers 16, 17, cassette sheet conveying roller 18, manual feed sheet pick-up roller 19, manual feed sheet supply roller 20 and manual feed separation roller 21, ADU conveying rollers 28, 29 and 30, pressing roller 25 and heating roller 26 in the fixing device, and so on, that is, is used for forming an image on the sheet as set out above.

A switching section 106 is provided between the 24V power source 104a and the load 105. A switch 107 in the switching section 106 is connected at one terminal to a load 105 side terminal and at the other terminal to either of a terminal 109 of the power source 104a and grounded-side terminal 110. The switching of the switch 107 is effected based on a instruction of controller 111.

The controller 111 sends a switching instruction to the switching section 106 to allow the switch 107 to be connected to a power source (104a)-side terminal 109 when the cover switch 103 is turned ON and to switch 107 to be connected to the grounded-side terminal 110 when the cover switch 103 is turned OFF. It is to be noted that the controller 111 may be constructed of a hardware, such as a circuit, or a software configuration.

An explanation will now be made below about the operation of the MFP1 when the operator exchanges a toner in the MFP1.

During use, the main switch 4 of the MFP1 is normally turned ON and the front cover 9 and side cover 10 are closed. That is, the cover switch 103 is turned ON and the switch 107 of the switching section 106 is connected to the power source (104a)-side terminal 109. Thus, the power is supplied from the main power source 101 to each associated unit in the MFP1.

In a state in which the power is supplied from the power source to a unit within the MFP1, the operator opens the front cover 9 for toner exchange. Then, the cover switch 103 is turned OFF in synchrony with the movement of the front cover 9. Then the controller 111 detects the turning OFF of the cover switch 103 and sends an instruction to the switching section 106 to switch the switch 107 from the power source (104a)-side terminal 109 to a grounded-side terminal 110. Based on this instruction, the switching section 106 switches the switch 107 from the power supply 104a-side terminal 109 to the grounded-side terminal 110. By doing so, any charge remaining in a capacitor, etc., of the load 105 is immediately discharged and any charge remaining in a capacitor, etc., connected to the power source 104a is also discharged, so that the operation of the load 105 is stopped.

After the toner exchange has been done, the front cover 9 is closed. Then the cover switch 103 is turned ON. The controller 111 detects the turning ON of the cover switch 103 and instructs the switching section 106 to change over the switch 107 from the grounded-side terminal 110 to the power source (104a)-side terminal. Based on this instruction, the switching section 106 changes over the switch 107 from the grounded-side terminal to the power source 104a-side terminal 109. By doing so, the power is again supplied to units within the MFP1.

Thus, when the operator opens the front cover 9 with the main switch 103 ON in the MFP1, the cover switch 103 is turned OFF in synchrony with the front cover 9. By doing so, power is not supplied from the main power source 101 to the power source 104a. Since the switch 107 is grounded, any residual charge on the load 105 is immediately discharged and any residual charge on the power source 104a is discharged. By doing so, even if any high voltage circuit, motor, etc., constituting the load 105 is operating, these are promptly stopped. Therefore, substantially simultaneously with the opening of the front cover 9, the operator can extend his or her hand into the inside of the MFP1 for toner exchange without involving any risk, because the load 105 is stopped.

Since the cover switch 103 is operated in synchrony with the side cover 10, the side cover 10 can be opened even if the main switch 4 is placed in the ON state in the MFP1 and the same advantage can also be obtained as in the case of opening the front cover.

### SECOND EMBODIMENT

An explanation will be made below about the second embodiment. In the second embodiment, the same reference numerals are employed to designate parts or elements corresponding to those shown in the first embodiment and any further explanation is omitted. In the second embodiment, a switching section is different in its configuration from a counterpart of the first embodiment.

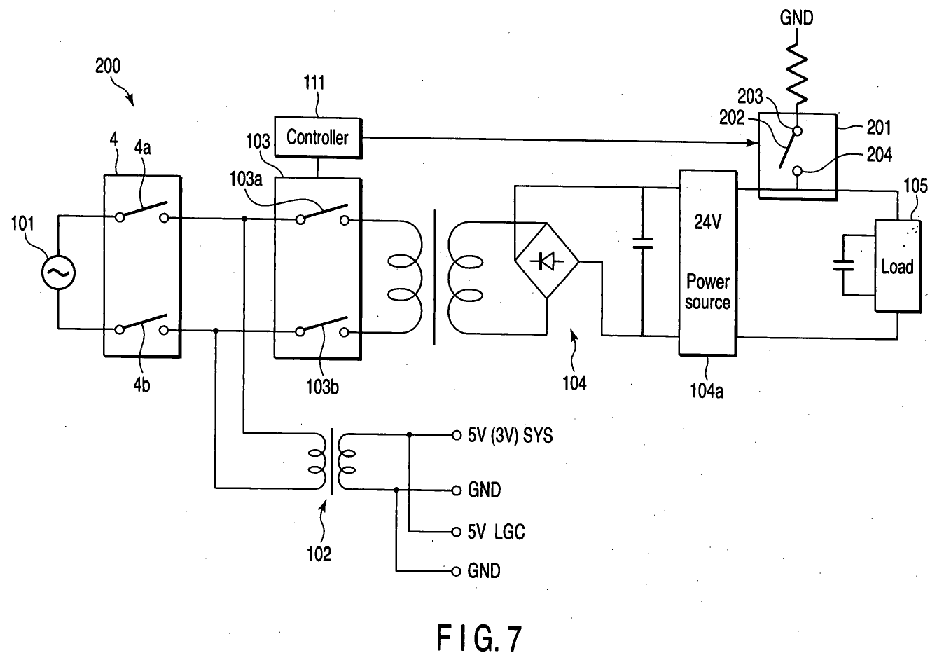

FIG. 7 is a view for explaining a safety circuit 200. The second embodiment is the same as the first embodiment except at a switching section 201 and an explanation is restricted to the different portion.

A switch 202 of the switch section 201 is connected at one terminal to a grounded-side terminal 203. The other terminal of the switch section 202 is so constructed as to be separately connected to a 24V power source 104a and a load (105)-side terminal 204. The separation of the switch 202 is made based on an instruction from a controller 111. The controller 111 issues an instruction to allow the switch 202 to be spaced away from a terminal 204 with a 24V power source 104a and load 105 connected thereto, when a cover switch 103 is turned ON, and the switch 202 to be connected to the terminal 204 with the 24V power source 104a and load 105 connected thereto when the cover switch 103 is turned OFF.

In an MFP1 having a thus structured safety circuit 200, when a front cover 9 or side cover 10 is opened, the cover switch 103 is turned OFF and no power is supplied to the load 105, so that the switch 202 in the switch section 201 is connected to a terminal 204 on a side connected to the power source 104a and load 105. For this reason, a remaining charge on the capacitor, etc., of the load 105 of a high voltage circuit, motor, etc., and a remaining charge on a capacitor of the 24V power source 104a can be simultaneously and rapidly discharged.

Also for the thus structured MFP1, it is possible to obtain the same advantage as in the case of the first embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

What is claimed is:

1. A safety circuit for image forming apparatus comprising:
a main switch configured to allow a power supply from the main power source to be switched in an ON/OFF fashion;
an openable/closable cover;
a cover switch configured to be turned OFF when the cover is opened and be turned ON when the cover is closed;
a load;
a load power source configured to be connected to the main power source through the main switch and cover switch to supply power which is generated based on power coming from the main power supply to the load;
a safety switch configured to promptly discharge any remaining charge on the load and load power source; and
a controller configured to, when the cover switch is turned OFF with the main switch ON, issue an instruction to the safety switch to immediately discharge the remaining charge.

2. A safety circuit for an image forming apparatus comprising:
a main switch configured to allow a power supply from a power source to be switched in an ON/OFF fashion;
an openable/closable cover;
a cover switch configured to be turned OFF when the cover is opened and be turned ON when the cover is closed;
a load;
a load power source configured to be connected to the main power source through the main switch and cover switch to supply power which is generated based on power coming from the main power source to the load;
a safety switch configured to be provided between the load and the load power source and connected at one terminal to a load-side terminal and at the other terminal to either of a load power source-side terminal and a grounded terminal; and
a controller configured to, when the cover switch is turned OFF with the main switch ON, issue an instruction to the safety switch to allow a connection to the grounded terminal.

3. A safety circuit for an image forming apparatus according to claim 2, wherein the cover is a front cover.

4. A safety circuit for an image forming apparatus according to claim 2, wherein the load is a conveying system motor for conveying a sheet for image formation.

5. A safety circuit for an image forming apparatus according to claim 4, wherein the conveying system motor is a motor for driving sheet conveying rollers.

6. A safety circuit for an image forming apparatus according to claim 4, wherein the conveying system motor is a motor for a fixing device.

7. A safety circuit for an image forming apparatus according to claim 2, wherein the load is a high voltage circuit.

8. A safety circuit for an image forming apparatus, comprising:
a main switch configured to allow power supply from a main power source to be switched in an ON/OFF fashion;
an openable/closable cover;
a cover switch configured to be turned OFF when the cover is opened and to be turned ON when the cover is closed;
a load;
a load power source configured to be connected through the main switch and cover switch to the main power source to supply power which is generated based on power coming from the main power source to the load;
a safety switch configured to be connected at one terminal to a load side-terminal and to set the other terminal in a state separable from a terminal connected to the load and the load power source, and
a controller configured to, when the cover switch is turned OFF with the main switch ON, issue an instruction to the safety switch to allow a connection to the load and the load power source terminal.

9. A safety circuit for an image forming apparatus according to claim 8, wherein the cover is a front cover.

10. A safety circuit for an image forming apparatus according to claim 8, wherein the load is a conveying system motor for conveying a sheet for image formation.

11. A safety circuit for an image forming apparatus according to claim 10, wherein the conveying system motor is a motor for driving conveying rolls for conveying a sheet.

12. A safety circuit for an image forming apparatus according to claim 10, wherein the conveying system motor is a motor for a fixing device.

13. A safety circuit for an image forming apparatus according to claim 8, wherein the load is a high voltage circuit.
